(19) United States
(12) Patent Application Publication
(10) Pub. No.: US 2023/0147025 A1
(43) Pub. Date: May 11, 2023

(54) Cidal Metal or Cidal Metal Alloy Pet Collar and Insert

(71) Applicant: Phyllis Kuhn, Seminole, FL (US)

(72) Inventor: Phyllis Kuhn, Seminole, FL (US)

(21) Appl. No.: 17/917,554

(22) PCT Filed: Apr. 26, 2021
(86) PCT No.: PCT/US21/29252

§ 371 Date: Oct. 7, 2022

Related U.S. Application Data
(60) Provisional application No. 63/014,745, filed on Apr. 24, 2020.

(51) Int. Cl. A01K 15/04; A01K 27/00

(52) U.S. Cl. CPC A01K 15/04; A01K 27/001

(57) ABSTRACT

A collar for a pet includes a mesh collar body, the mesh collar body comprising a cidal metal or cidal metal alloy in which the cidal metal or cidal metal alloy is the major structural component of the collar. The mesh collar body extends from and around the neck of the pet to limit interaction of the pet's head or mouth with other parts of the pet's body. The mesh collar body allows air surrounding and within the collar to pass through the collar to provide cidal action, air purification, and self-disinfection. The collar can be fashioned into an elizabethan collar in which the mesh collar body has a truncated conical, flat, or other shape. The invention can also be provided as a truncated conical insert for a conventional elizabethan collar.

### BACKGROUND OF THE INVENTION

Like humans, dogs, cats, and other pets are susceptible to many germ-based illnesses and diseases. When injured, pets often resort to licking or biting open sores, which can further aggravate the injury and/or introduce harmful pathogens leading to further infection and illnesses. Elizabethan collars are often utilized to prevent pet wound licking and other self-harm by forming a barrier between a pet's head/mouth and the remainder of the pet's body without interfering with other life activities.

In conventional paper/carboard or woven fiber elizabethan collars, the utilized material may not always provide a physical barrier to water or blood. Rather, such materials generally exhibit wicking which actually promotes the penetration of water or blood. Even if a non-wicking or impermeable material such as plastic is used, water or blood can be splashed and the open collar can still be contaminated with environmental materials that then retain germs near the pet's face, mouth, and nose. Similarly, the construction of conventional elizabethan collars also vary considerably in air permeability. Thus, elizabethan collars also vary greatly in their ability to serve as a bather to air flowing in certain directions.

Most bacteria, viruses, and other pathogens can be eliminated or greatly reduced with the use of cidal (pathogen and microbe-killing) metals such as but not limited to copper, silver, gold, and related alloys such as bronze and brass. However, elizabethan collars that lack such materials cannot take advantage of such cidal properties.

### SUMMARY OF THE INVENTION

A collar for a pet includes a mesh collar body, the mesh collar body comprising a cidal metal or cidal metal alloy in which the cidal metal or cidal metal alloy is the major structural component of the collar. The mesh collar body extends from and around the neck of the pet to limit interaction of the pet's head or mouth with other parts of the pet's body. The mesh collar body allows air surrounding and within the collar to pass through the collar to provide cidal action, air purification, and self-disinfection.

The collar can be fashioned into an elizabethan collar in which the mesh collar body has a flat, truncated conical, or other shape. The invention can also be provided as a truncated conical insert for a conventional elizabethan collar.

### BRIEF DESCRIPTION OF THE DRAWINGS

For a more complete understanding and appreciation of this invention, and its many advantages, reference will be made to the following Detailed Description of the Invention taken in conjunction with the accompanying drawings.

FIG. 1 is front view of a pet wearing a collar according to one embodiment of the invention;

FIG. 2 is perspective view of the collar of FIG. 1;

FIG. 3 is a closeup perspective view of the collar of FIG. 1;

FIG. 4 is front view of a pet wearing an insert and an elizabethan collar according to one embodiment of the invention;

FIG. 5 is a side exploded view of the insert and elizabethan collar of FIG. 4;

FIG. 6 is a closeup perspective view of the insert positioned within the elizabethan collar of FIG. 5;

FIG. 7A is a perspective view of an insert for and elizabethan collar according to one embodiment of the invention;

FIG. 7B is a perspective view of an insert for an elizabethan collar according to one embodiment of the invention;

FIG. 7C is a perspective view of an insert for an elizabethan collar according to one embodiment of the invention; and

FIG. 8 is front view of a pet wearing a collar according to one embodiment of the invention.

### DETAILED DESCRIPTION OF THE INVENTION

Referring to the drawings, some reference numerals are used to designate the same or corresponding parts through several of the embodiments and figures shown and described. Variations in corresponding parts are denoted in specific embodiments with the addition of lowercase letters. Subsequent variations in components that are depicted in the figures but not described are intended to correspond to the specific embodiments mentioned earlier and are discussed to the extent that they vary in form or function. It will be understood generally that variations in the embodiments could be interchanged without deviating from the intended scope of the invention.

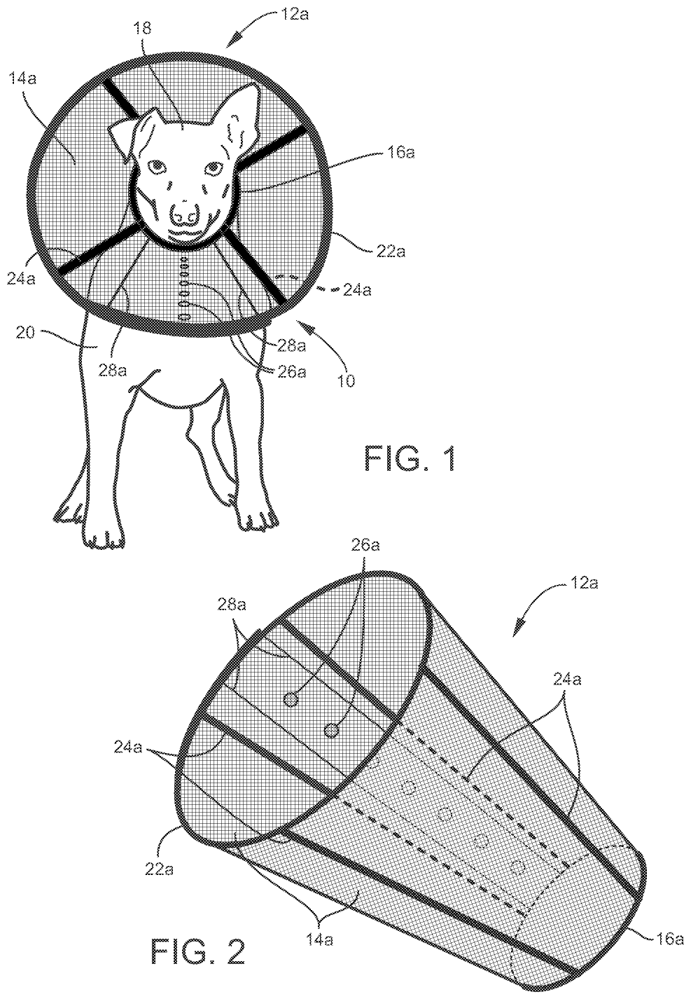

FIG. 1 depicts a front view of a collar 12a of the invention extending from and around the neck of a pet dog 10. As best understood by comparing FIG. 1 with the side perspective view of the collar 12a in FIG. 2, the collar 12a is an elizabethan collar having a mesh collar body 14a comprising a cidal metal or cidal metal alloy which forms the major structural component of the collar 12a.

In this conceptual example of FIGS. 1 and 2, the mesh collar body 14a is copper mesh having an approximate wire diameter of 0.0045 inches and width opening of 0.00555 inches with approximately 30.3% open area and with approximately 100×100 mesh per linear inch, such as item # 100×100 0.0045 cu or similar item available from the Belleville Wire Cloth Company of Cedar Grove, N.J. Although shown and described with this specific size, rigidity, grade, and other characteristics of the identified example copper mesh, it will be appreciated that most other meshes of cidal metal or cidal metal alloy can also be appropriately implemented within the contemplated scope of the invention.

In addition, although copper is shown and described in this conceptual example of FIGS. 1 and 2, it will be appreciated that meshes of other cidal metals or cidal metal alloys, such as but not limited to silver, gold, silver or gold alloys, brass, bronze, other copper alloys, or other such materials can also be implemented within the contemplated scope of the invention.

Referring again to FIGS. 1 and 2, the collar 12a, being an elizabethan collar, has a truncated conical shape. A neck hoop stiffener 16a is positioned around the neck of the dog 10, with the mesh collar body 14a widening from the neck toward the top of the head of the dog 10 to create a barrier between the dog's head 18 with other parts of the dog's body 20. Due to the truncated conical shape of the collar 12a, a distal hoop stiffener 22a is provided having a larger diameter than the neck hoop stiffener 16a.

Several stiffener rods 24a extend along the mesh collar body 14a from the neck hoop stiffener 16a to the distal hoop stiffener 22a to permit increased rigidity to the collar 12a. Each of the stiffener rods 24a, the neck hoop stiffener 16a, and the distal hoop stiffener 22a are sufficiently rigid to maintain the truncated conical shape of the collar 12a while the collar 12a is attached to the neck of the dog 10, and therefore each may be constructed of a rigid material such as stiff wire, bar, wood, or rigid plastic. It is also possible to construct each of the stiffener rods 24a, the neck hoop stiffener 16a, and the distal hoop stiffener 22a of a rigid material that is also a cidal metal or cidal metal alloy to enhance the overall cidal effectiveness of the collar 12a.

Several snap connectors 26a are positioned (side connector snaps) along the mesh collar body 14a to connect the overlapping edges 28a of the cidal mesh collar body material. The snap connectors 26a can be unsnapped to allow the overlapping edges 28a to come apart when fitting the neck hoop stiffener 16a and collar 12a around the neck of the pet dog 10. The snap connectors 26a also allow for easy fitting and securement once the collar 12a is in place.

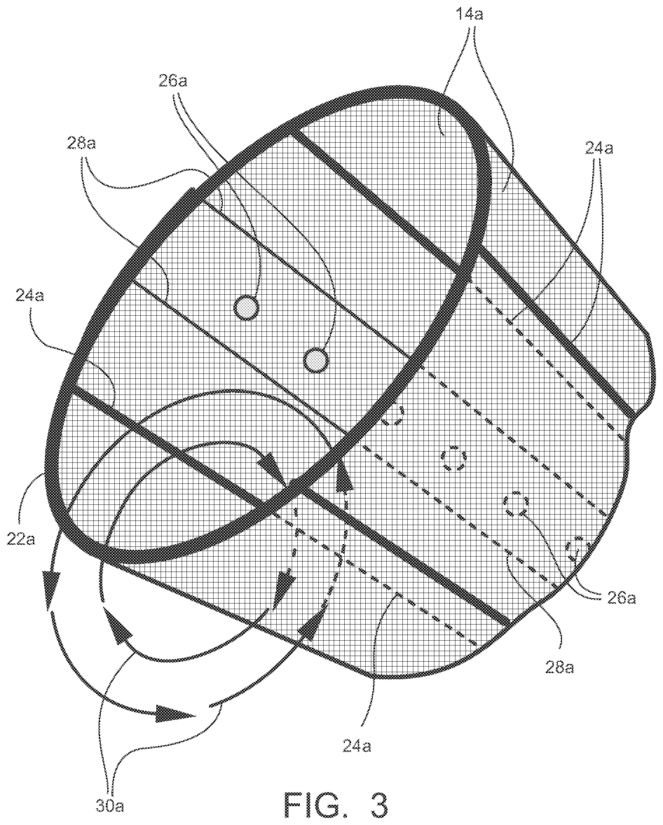

FIG. 3 depicts a closeup perspective view of the collar 12a of FIGS. 1 and 2 near the distal hoop stiffener 22a. As best understood by comparing FIG. 3 with FIGS. 1 and 2, when the collar 12a is positioned with the neck hoop stiffener 16a around the neck of the pet dog 10 and the mesh collar body 14a secured with the snap connectors 26a as shown in FIG. 1, both reciprocating and multidirectional movement of air occurs due to a combination of the pet dog's own respiration, air movement resulting from physical movement of the pet dog 10 itself, and from natural air diffusion. As shown in FIG. 3, linear, reciprocating, circular flowing and counterflowing air 30a passes through the mesh collar body 14a. In the depicted example, as air interacts with the copper of the mesh collar body 14a, the flowing air 30a is purified as it contacts the cidal metal material, killing microbes and pathogens. As shown, the flowing air 30a can also pass repeatedly through the collar body 14a due to breathing or movement by the pet dog 10. This repeated interaction between the flowing air 30a and mesh collar body 14a creates a “scrubbing” effect on the flowing air. This interaction also allows copper ions to be drawn by the flowing air 30a, diffused within and around the collar 12a, and eventually drawn into the respiratory tract of the pet dog 10 for the benefit of additional cidal effects that are therapeutic and harmless to the animal. The cidal properties of the copper mesh collar body 14a also allow the collar 12a to self-disinfect.

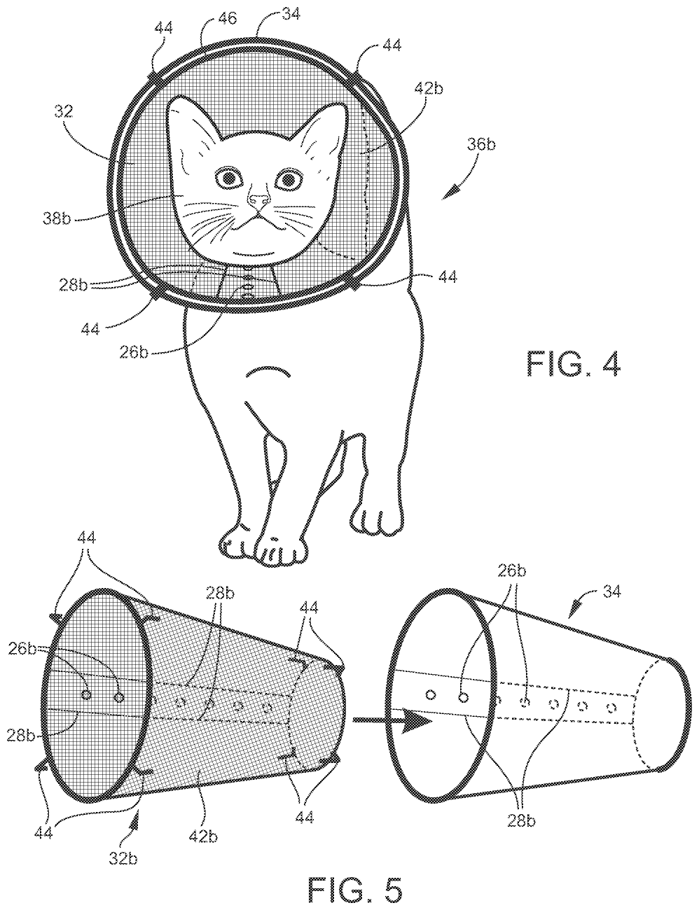

Although shown and described as an elizabethan collar having a cidal metal or cidal metal alloy as the major structural component, it will be appreciated the invention can also be appropriately implemented as an insert to a conventional elizabethan collar within the contemplated scope of the invention. For example, FIG. 4 depicts a front view of an insert 32b positioned within a conventional elizabethan collar 34 and positioned on the neck of a pet cat 36b. The insert 32b and conventional elizabethan collar 34 extend outwardly from the neck of the cat 36b to prevent contact between the cat's head 38b and the rest of its body 40b.

As best understood by comparing FIG. 4 with the exploded view of the insert 32b in FIG. 5 prior to insertion into the elizabethan collar 34, the collar 34 is constructed of a conventional collar material such as paper, carboard, plastic, or woven fibrous material such cloth, fabric, or cotton. The extent to which the collar 34 forms a barrier to air or liquid flow will therefore vary greatly depending on the material utilized in the collar's construction. The insert 32b includes a mesh insert body 42b comprising a cidal metal or cidal metal alloy which forms the major structural component of the insert 32b.

In this illustrative example, the mesh insert body is 32b is constructed of copper mesh having an approximate wire diameter of 0.0045 inches and width opening of 0.00555 inches with approximately 30.3% open area and with approximately 100×100 mesh per linear inch, such as item #100×100 0.0045 cu or similar item available from the Belleville Wire Cloth Company of Cedar Grove, N.J. Although shown and described with this specific size, rigidity, grade, and other characteristics of the identified example copper mesh, it will be appreciated that most other meshes of cidal metal or cidal metal alloy can also be appropriately implemented within the contemplated scope of the invention.

Comparing FIGS. 4 and 5, both the insert 32b and elizabethan collar 34 have truncated conical shapes allowing the insert 32b to fit within the collar 34 after insertion as shown in FIG. 5. Both the insert 32b and collar 34 also include snap connectors 26b and overlapping edges 28b allowing for fitting over the head 38b and attachment to the neck of the cat 36b. Clips 44 at each insert opening allow for securement of the insert 32b once positioned in the collar 34. The resulting gap 46 between the mesh insert body 42b of the insert 32b and the surrounding elizabethan collar 34 can vary considerably in size depending on the embodiment, but in many contemplated embodiments may be of sufficient size to allow at least a minute amount of airflow. It will however be appreciated that in other contemplated embodiments, the gap 46 will be very small or even virtually nonexistent if the mesh insert body 42b rests flush against the collar 34.

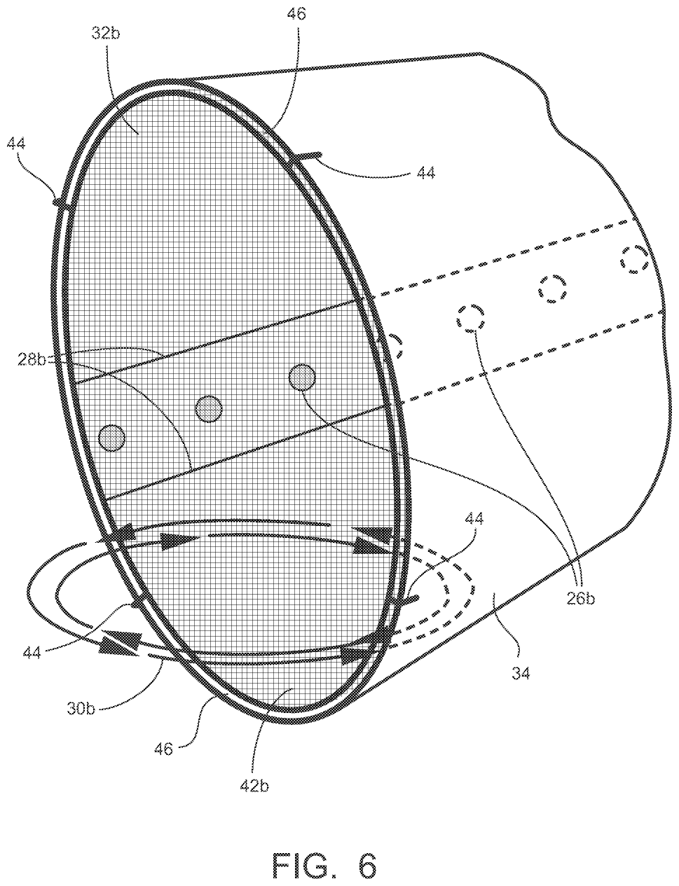

Now comparing FIGS. 4 and 5 with the closeup view of the elizabethan collar 34 and inserted and positioned insert 32b depicted in FIG. 6, linear, reciprocating, circular flowing and counterflowing air 30b passes into the elizabethan collar 34 and insert 32b. The amount of air passing through the walls of the elizabethan collar 34 itself will depend on the chosen construction material of the collar 34. However, assuming a fully or mostly air and liquid impermeable material such as plastic or coated paper, airflow 30b will be in through the open fronts of the insert 32 and collar 34, passing through the mesh insert body 42a of the insert 32 and against the inside surfaces of the collar 34.

The level of air flow between the inside surfaces of the collar 34 and insert body 42a will at least partly depend on the magnitude of the gap 46. If there is a significant gap size, as shown in FIG. 6, then the linear, reciprocating, circular flowing and counterflowing air flow will include air flow 30b through the gap 46 as depicted in the figure. Even if the gap 46 is absent, air will flow over the copper cidal surfaces of the mesh insert body 42b, and to at least some extent, through the elizabethan collar 34 to the insert body 42b if the collar 34 is constructed of an air-permeable material. If the collar 34 forms an obstruction to air flow, but nevertheless can wick or absorb liquids from the environment, the cidal copper of the mesh insert body 42b will nevertheless provide purifying cidal action both from direct contact with interacting air and liquids and from the release of copper ions into the flowing air 30b, killing microbes and pathogens. The resulting flowing air 30b repeatedly passing through the mesh insert body 42b also creates a “scrubbing” effect on the flowing air and results in diffusion of copper ions within and around the collar 12a, and eventually drawn into the respiratory tract of the cat 36b for beneficial cidal effects.

Although the insert of the invention has been shown and described as being copper mesh, it will be appreciated that meshes of other cidal metals or cidal metal alloys, such as but not limited to silver, gold, silver or gold alloys, brass, bronze, other copper alloys, or other such materials can also be implemented within the contemplated scope of the invention. It will be further appreciated that the use of any such cidal metal or cidal metal alloy meshes for the insert of the invention can be combined with use of elizabethan collars of any material or of any level of air or liquid permeability within the contemplated scope of the invention.

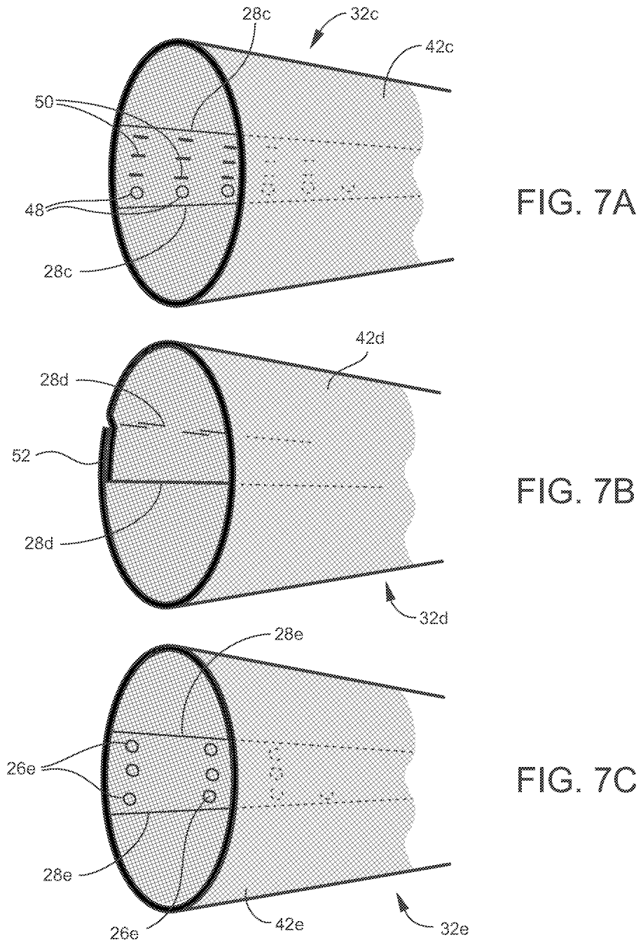

It will be further appreciated that modifications can be made to the invention to allow for enhanced adjustability or for the fitting of the invention to animals of varying sizes. A number of such contemplated adjustable embodiments are included in FIGS. 7A-B. For example, FIG. 7A depicts an insert 32c of the invention having a mesh insert body 42c in which the overlapping edges 28c include buttons 48, each button having multiple corresponding button holes 50 to allow for variable tightness of the insert 32c around the neck of a pet. As another example, FIG. 7B depicts a similar insert 32d of the invention in which the overlapping edges 28d of the mesh insert body 42d include a VELCRO™ fastener which also allows for variable neck tightness. In a further example, FIG. 7C depicts another insert 32e having multiple snap connectors 26e at the overlapping edges 28e that similarly allow for selective variations in neck tightness.

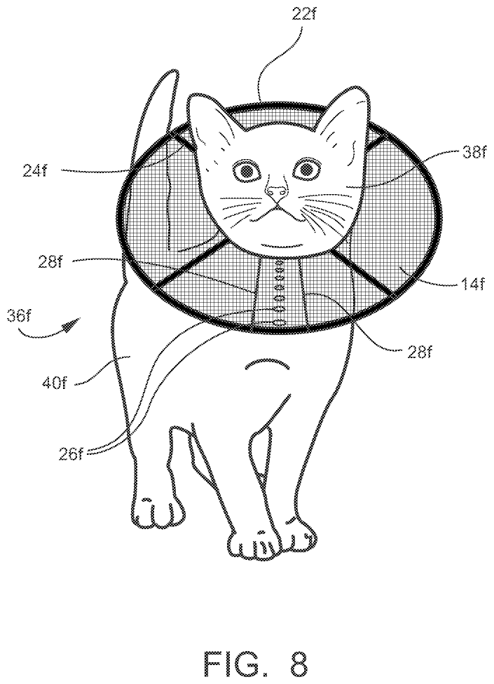

It will be further appreciated the invention can incorporate non-conically shaped collars or inserts within the contemplated invention scope. For example, FIG. 8 depicts a front view of a pet cat 36f wearing a collar 12f according to one embodiment of the invention having flat plane-shaped collar body 14f of cidal metal or cidal metal alloy mesh. The collar 12f also includes stiffener rods 24f extending from a neck hoop stiffener 16f (not shown) around the cat's neck to a distal hoop stiffener 22f to provide stiffness and maintain the flat plane shape of the collar body 14f. Despite the flat plane shape of the collar body 14f, the collar 12f is sized to provide a barrier preventing contact between the cat's head 38f and the rest of the cat's body 40f, thereby allowing less constriction of the head 38f while still providing many of the cidal benefits of conically-shaped collars.

Although the invention has been shown and described as utilizing cidal metal or cidal metal alloy mesh collars and inserts that are conically or flat plane-shaped, it will be appreciated that other collar and insert shapes are also possible within the contemplated scope of the invention. Those skilled in the art will also realize that this invention is capable of other embodiments different from those shown and described. It will be appreciated that the detail of the structure of the disclosed apparatuses and methodologies can be changed in various ways without departing from the invention itself. Accordingly, the drawings and Detailed Description of the Invention are to be regarded as including such equivalents as do not depart from the spirit and scope of the invention.

1. A collar for a pet comprising:
a mesh collar body, said mesh collar body comprising cidal metal or cidal metal alloy wherein said cidal metal or cidal metal alloy is the major structural component of said collar;
said mesh collar body being positioned to extend from and around the neck of the pet to limit interaction of the head or mouth of the pet with other parts of the body of the pet; and
said mesh collar body allowing air surrounding and within said collar to pass through said collar to provide cidal action, air purification, and self-disinfection.

2. The collar of claim 1 wherein said collar is adjustable to accommodate different pet neck sizes.

3. The collar of claim 1 wherein said collar is adjustable to accommodate different pet neck sizes with snap fasteners.

4. The collar of claim 1 wherein said collar is adjustable to accommodate different pet neck sizes with a VELCRO™ fastener.

5. The collar of claim 1 wherein said collar is adjustable to accommodate different pet neck sizes with buttons.

6. The collar of claim 1 further comprising a neck hoop stiffener.

7. The collar of claim 1 further comprising a distal hoop stiffener.

8. The collar of claim 1 further comprising:
a neck hoop stiffener;
a distal hoop stiffener; and
at least one stiffener rod for securing said neck hoop stiffener and said distal hoop stiffener.

9. The collar of claim 1 wherein said mesh collar body is positioned to allow air to reciprocate through said collar to allow for air scrubbing.

10. An elizabethan collar for a pet comprising:
a mesh collar body, said mesh collar body comprising cidal metal or cidal metal alloy wherein said cidal metal or cidal metal alloy is the major structural component of said collar;
said mesh collar body having a truncated conical shape and positioned to extend from and around the neck of the pet to limit interaction of the head or mouth of the pet with other parts of the body of the pet; and
said mesh collar body allowing air surrounding and within said collar to pass through said collar to provide cidal action, air purification, and self-disinfection.

11. The elizabethan collar of claim 10 wherein said elizabethan collar is adjustable to accommodate different pet neck sizes.

12. The elizabethan collar of claim 10 wherein said elizabethan collar is adjustable to accommodate different pet neck sizes with snap fasteners.

13. The elizabethan collar of claim 10 wherein said elizabethan collar is adjustable to accommodate different pet neck sizes with a VELCRO™ fastener.

14. The elizabethan collar of claim 10 wherein said elizabethan collar is adjustable to accommodate different pet neck sizes with buttons.

15. The elizabethan collar of claim 10 further comprising a neck hoop stiffener.

16. The elizabethan collar of claim 10 further comprising a distal hoop stiffener.

17. The elizabethan collar of claim 10 further comprising:
a neck hoop stiffener;
a distal hoop stiffener; and
at least one stiffener rod for securing said neck hoop stiffener and said distal hoop stiffener.

18. The elizabethan collar of claim 10 wherein said mesh collar body is positioned to allow air to reciprocate through said elizabethan collar to allow for air scrubbing.

19. An insert for an elizabethan collar for a pet comprising:
a mesh insert body, said mesh insert body comprising cidal metal or cidal metal alloy wherein said cidal metal or cidal metal alloy is the major structural component of said insert;
said mesh insert body having a truncated conical shape and positioned to be inserted into a truncated conical elizabethan collar;
said insert body being positioned to extend from and around the neck of the pet when said insert body is inserted into the elizabethan collar when said elizabethan collar extends from and around the neck of the pet to limit interaction of the head or mouth of the pet with other parts of the body of the pet; and
said mesh insert body allowing air surrounding and within said insert and air within said elizabethan collar to pass through said collar body to provide cidal action, air purification, and self-disinfection.

20. The insert of claim 19 wherein said insert is adjustable to accommodate different pet neck sizes.

21. The insert of claim 19 wherein said insert is adjustable to accommodate different pet neck sizes with snap fasteners.

22. The insert of claim 19 wherein said insert is adjustable to accommodate different pet neck sizes with a VELCRO™ fastener.

23. The insert of claim 19 wherein said elizabethan collar is adjustable to accommodate different pet neck sizes with buttons.

24. The insert of claim 19 further comprising a neck hoop stiffener.

25. The insert of claim 19 further comprising a distal hoop stiffener.

26. The insert of claim 19 further comprising:
a neck hoop stiffener;
a distal hoop stiffener; and
at least one stiffener rod for securing said neck hoop stiffener and said distal hoop stiffener.

27. The insert of claim 19 wherein said mesh insert body is positioned to allow air to reciprocate through said insert to allow for air scrubbing.

28. The insert of claim 19 further comprising at least one clip to secure said insert within the elizabethan collar.
